(19) United States
(12) Patent Application Publication
(10) Pub. No.: US 2022/0055482 A1
(43) Pub. Date: Feb. 24, 2022

(54) Systems And Methods For Horizon Digital Virtual Steering Wheel Controller

(71) Applicant: Ford Global Technologies, LLC, Dearborn, MI (US)

(72) Inventors: Brian Brissman, Canton, MI (US); Carrie Bittick, Rochester Hills, MI (US); Alec Glen Struthers, Northville, MI (US); Jason Keenan, Dearborn, MI (US); Ross Kern, Novi, MI (US); Mike Lawrence Dugan, Ann Arbor, MI (US); Joe Scott, Saline, MI (US); Michael Arbaugh, Rochester Hills, MI (US)

(21) Appl. No.: 17/399,143

(22) Filed: Aug. 11, 2021

Related U.S. Application Data
(60) Provisional application No. 63/069,456, filed on Aug. 24, 2020.

(51) Int. Cl. B60K 37/06; B62D 1/04; B60K 35/00

(52) U.S. Cl. CPC B60K 37/06; B62D 1/046; B60K 35/00; B60K 2370/158; B60K 2370/167; B60K 2370/155; B60K 2370/736; B60K 2370/1529

(57) ABSTRACT

Systems and methods are provided herein to simplify the functional offerings of vehicle control settings to those most frequently used by drivers. A virtual image of the switch set is depicted in the large information display of a vehicle showing the appropriate, context-based control functions for the task at hand. With the function graphics/instruction shown in the display, the graphics may be removed from the switch itself allowing for the user to interact with multipurpose controls that are easily understood and not limited by hard graphics printed on a switch. The use of the display may help a driver stay focused on the road.

### CROSS-REFERENCE TO RELATED APPLICATIONS

This application claims priority to and the benefit of U.S. provisional patent application No. 63/069,456, filed Aug. 24, 2020, which is hereby incorporated by reference herein in its entirety.

### BACKGROUND

Steering wheel controls have emerged as a desirable location to place features in an effort to offer quick and easy access to features believed to be important to the driver and to help them remain focused on the road, e.g., eyes on the road, hands on the wheel. The migration of features to the steering wheel has added considerable complexity to the steering wheel and the use of its controls.

It is therefore be desirable to provide physicality at the steering wheel, as well as steering wheel interactions that are quick, tactile, and blind like in operation of the most frequently used controls, e.g., functions that are most needed while driving, such that drivers need not navigate deep menu structures from the steering wheel.

It is with respect to these and other considerations that the disclosure made herein is presented.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 illustrates a virtual steering wheel controller system in accordance with the principles of the present disclosure.

FIGS. 2A to 2C illustrate an exemplary steering wheel constructed in accordance with the principles of the present disclosure.

FIG. 3 shows some example components that may be included in a virtual steering wheel controller platform in accordance with the principles of the present disclosure.

FIGS. 4A to 4F illustrate various functionalities provided by the virtual steering wheel controller system of FIG. 1.

FIGS. 5A to 5D illustrate various functionalities of the virtual steering wheel controller system virtually displayed on an exemplary display in accordance with the principles of the present disclosure.

FIGS. 6A to 6C illustrate a steering wheel adjustment functionality in accordance with the principles of the present disclosure.

FIGS. 7A to 7D illustrate a mirror adjustment functionality in accordance with the principles of the present disclosure.

FIGS. 8A and 8B illustrate a call functionality in accordance with the principles of the present disclosure.

FIGS. 9A to 9C illustrate driver assist functionalities in accordance with the principles of the present disclosure.

FIG. 10 is a chart illustrating an exemplary method for controlling vehicle control settings using the virtual steering wheel controller system in accordance with the principles of the present disclosure.

### DETAILED DESCRIPTION

### Overview

Systems and methods are provided herein to simplify the functional offerings of vehicle control settings to those most frequently used by drivers. Functions are classified as primary and secondary to limit the number of functions shown to the user at one time. This allows for a compact and simple switch set, e.g., 10-15 position switch set, improving findability and memorable operation. A virtual image of the switch set is depicted in the large information display showing the appropriate control for the task at hand (contextually appropriate controls). With the function graphics/instruction shown in the display, the graphics may be removed from the switch itself allowing for the user to interact with multipurpose controls that are easily understood and not limited by hard graphics printed on a switch. The use of the display reduces the driver's downward gaze when interacting with steering wheel functions, thereby keeping their eyes up and out closer to the road. Capacitive technology is leveraged to offer proximity sensing (finger trace) capability helping the user identify the function they wish to interact with without glancing down at the switch itself, which is an improvement over having to remove your thumb from the switch to see the labels. Additionally, driver adjustment settings may be added to the steering wheel as it creates a natural postural correct interaction for the driver.

To help create an advanced set of steering wheel controls described herein, a thorough evaluation of the current functionality was completed prior to ideating on concepts. For example, control functionalities found to be used infrequently were consolidated or eliminated based on leveraging surveys and big data analysis. In addition, traditional cluster settings were moved to the center screen to eliminate menu buttons, which opens up space in the display for the digital virtual switch. Moreover, to take advantage of the driver's natural postural position, power mirrors, power steering column, and power pedal controls were moved to the steering wheel, such that the user's hands would remain on the wheel when making these adjustments. This enables the addition of mirrors, tilt-tele, power pedals, etc., which creates a great experience for the driver by offering adjustments at their fingertips in their natural driving positions. Through the use of the virtual switch, the active functional state of these multipurpose buttons is easily communicated to the driver.

In accordance with some aspects of the present disclosure, the systems described herein include large vehicle information displays including, but not limited to, high heads down displays, panoramic displays, HUD, and large clusters. By leveraging the larger displays, a digital virtual image of the switch may be created in the information display. Accordingly, the driver still physically interacts with the switch, but their eyes glance no lower than the informational display, which offers an improved downward viewing angle.

Moreover, the system removes physical label graphics on the actuators of the switch set. With a digital image of the contextually appropriate control set in the information display, there is no longer a need to place graphics on the switches themselves. Accordingly, there is no longer a need to glance down to the switch itself. In addition, the lack of graphics offers the ability to swap left hand and right hand controls.

The systems described herein provide contextual-dependent functionality, e.g., the system offers the right control at the right time. For example, the right hand primary first surface controls may include audio functions, but when a paired phone receives an incoming phone call, those same controls change purpose allowing the user to quickly answer the phone call, which preserves functionality while minimizing buttons. Thus, the functions associated with the controls are contextually dependent on the vehicle control settings accessible by the user. The active control set is easily communicated to the driver virtually using the large information display. Moreover, the amount of first surface buttons may be reduced. Specifically, the contextual ability of the switch enables limitation of the amount of first surface buttons to, e.g., 10-15 buttons, thereby improving findability and memorable operation.

In addition, the system utilizes a capacitive switch set, which supports proximity sensing, e.g., finger trace. For example, the system detects and communicates to the user the location of their thumb on the switch and uses the signal to display the virtual switch image in the HMI, which supports blind like operation. This enhances the experience by allowing the user to keep their hands on the switch while identifying the intended control. Moreover, the switch utilizes a haptic response to tactilely communicate the interaction with the switch to the user even without looking at the display. Accordingly, with the control set being displayed virtually to the driver, the switch is easily adaptable to other purposes and future functionality that could be deployed via OTA updates.

### Illustrative Embodiments

The disclosure will be described more fully hereinafter with reference to the accompanying drawings, in which example embodiments of the disclosure are shown. This disclosure may, however, be embodied in many different forms and should not be construed as limited to the example embodiments set forth herein. It will be apparent to persons skilled in the relevant art that various changes in form and detail can be made to various embodiments without departing from the spirit and scope of the present disclosure. Thus, the breadth and scope of the present disclosure should not be limited by any of the above-described example embodiments but should be defined only in accordance with the following claims and their equivalents. The description below has been presented for the purposes of illustration and is not intended to be exhaustive or to be limited to the precise form disclosed. It should be understood that alternate implementations may be used in any combination to form additional hybrid implementations of the present disclosure. For example, any of the functionality described with respect to a particular device/component may be performed by another device/component. Further, while specific device characteristics have been described, embodiments of the disclosure may relate to numerous other device characteristics. Further, although embodiments have been described in language specific to structural features and/or methodological acts, it is to be understood that the disclosure is not necessarily limited to the specific features or acts described. Rather, the specific features and acts are disclosed as illustrative forms of implementing the embodiments.

Certain words and phrases are used herein solely for convenience and such words and terms should be interpreted as referring to various objects and actions that are generally understood in various forms and equivalencies by persons of ordinary skill in the art.

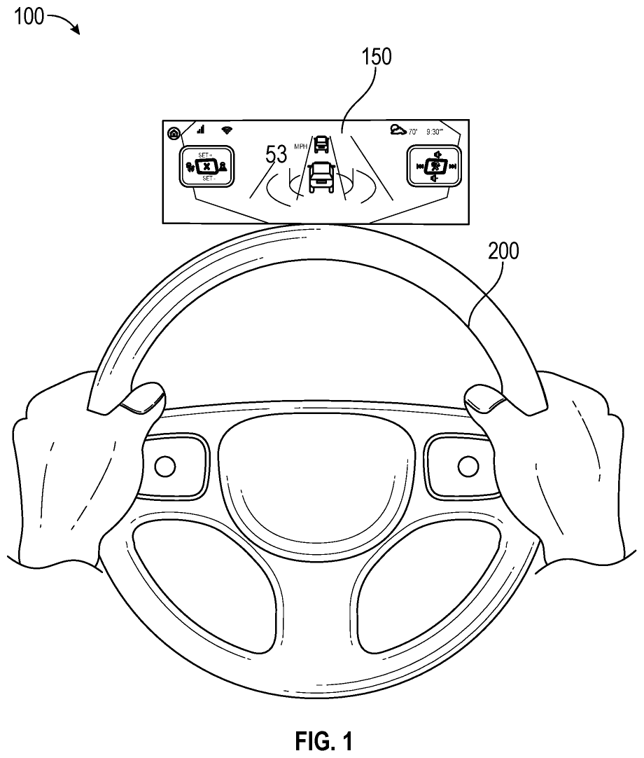

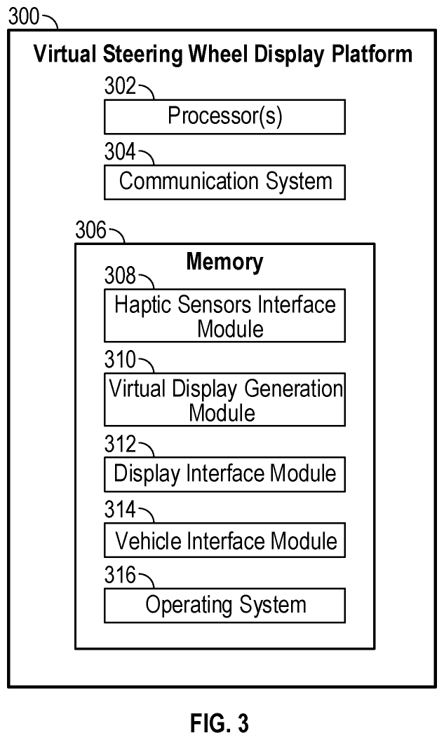

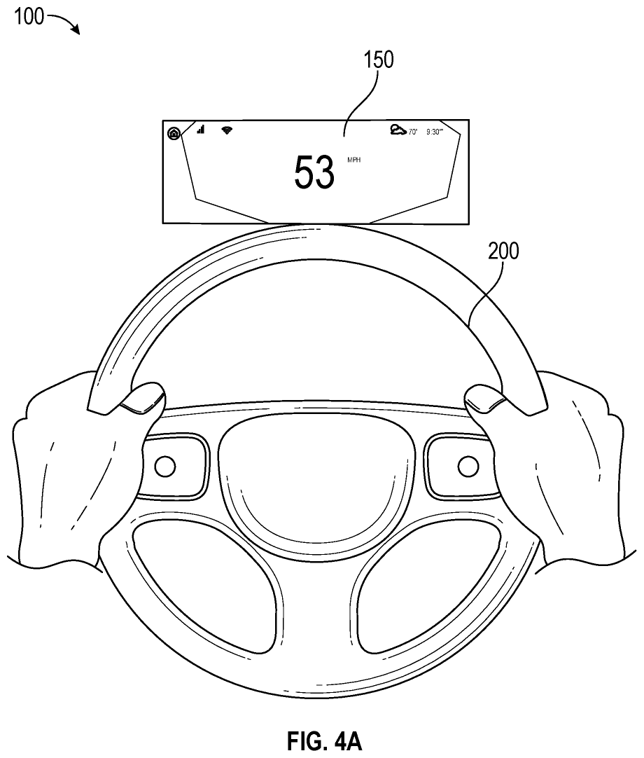

Referring now to FIG. 1, an exemplary virtual steering wheel controller system is provided. As shown in FIG. 1, system 100 includes a vehicle having steering wheel 200 operatively coupled to display 150, e.g., via virtual steering wheel controller platform 300, described in further detail below with regard to FIG. 3.

The vehicle may be a manually driven vehicle (e.g., no autonomy) and/or configured and/or programmed to operate in a fully autonomous (e.g., driverless) mode (e.g., Level-5 autonomy) or in one or more partial autonomy modes which may include driver assist technologies, e.g., adaptive cruise control. Examples of partial autonomy (or driver assist) modes are widely understood in the art as autonomy Levels 1 through 4. A vehicle having a Level-0 autonomous automation may not include autonomous driving features. An autonomous vehicle (AV) having Level-1 autonomy may include a single automated driver assistance feature, such as steering or acceleration assistance. Adaptive cruise control is one such example of a Level-1 autonomous system that includes aspects of both acceleration and steering. Level-2 autonomy in vehicles may provide partial automation of steering and acceleration functionality, where the automated system(s) are supervised by a human driver that performs non-automated operations such as braking and other controls. In some aspects, with Level-2 autonomous features and greater, a primary user may control the vehicle while the user is inside of the vehicle, or in some example embodiments, from a location remote from the vehicle but within a control zone extending up to several meters from the vehicle while it is in remote operation. Level-3 autonomy in a vehicle can provide conditional automation and control of driving features. For example, Level-3 vehicle autonomy typically includes “environmental detection” capabilities, where the vehicle can make informed decisions independently from a present driver, such as accelerating past a slow-moving vehicle, while the present driver remains ready to retake control of the vehicle if the system is unable to execute the task. Level-4 autonomous vehicles can operate independently from a human driver, but may still include human controls for override operation. Level-4 automation may also enable a self-driving mode to intervene responsive to a predefined conditional trigger, such as a road hazard or a system failure. Level-5 autonomy is associated with autonomous vehicle systems that require no human input for operation, and generally do not include human operational driving controls. According to embodiments of the present disclosure, virtual steering wheel controller platform 300 may be configured and/or programmed to operate with a vehicle having a Level-4 or Level-5 autonomous vehicle controller.

Virtual steering wheel controller platform 300 may be stored and executed via a vehicle control module of the vehicle. The vehicle control module may communicate with steering wheel 200, display 150, and the electrical and mechanical components of the vehicle over a network, e.g., any one, or a combination of networks, such as a local area network (LAN), a wide area network (WAN), a telephone network, a cellular network, a cable network, a wireless network, and/or private/public networks, such as the Internet. For example, the network may support communication technologies, such as TCP/IP, Bluetooth, cellular, near-field communication (NFC), Wi-Fi, Wi-Fi direct, machine-to-machine communication, man-to-machine communication, and/or a vehicle-to-everything (V2X) communication.

Display 150 is configured to virtually display information indicative of the switch set of steering wheel 200 and vehicle control settings, as described in further detail below. As shown in FIG. 1, display 150 may be integrated into the dashboard of the vehicle, such that display 150 is within the line-of-sight of the driver of the vehicle. Additionally, or alternatively, display 150 may include a heads up display such that display 150 is projected onto, e.g., the windshield of the vehicle, such that display 150 is within the line-of-sight of the driver of the vehicle.

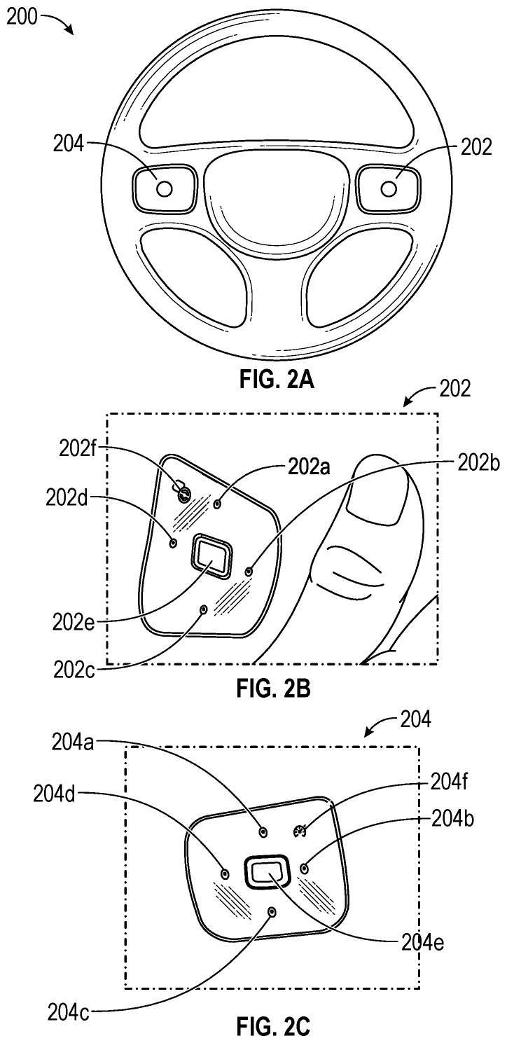

As shown in FIG. 2A, steering wheel 200 includes a switch set, e.g., right hand controls 202 and left hand controls 204, having a plurality of actuators which may be individually actuated by the driver. As shown in FIG. 2A, the switch set of steering wheel 200 may be label-less, e.g., unmarked, to provide contextual adaptability as described in further detail below. Each actuator of the switch set may include a haptic sensor for sensing when the driver's finger or thumb is positioned over the respective actuator. Each actuator may provide haptic feedback based on a signal generated by the haptic sensor to inform the driver where their finger/thumb is relative to the switch set as virtually displayed on display 150. Moreover, each actuator may be physically actuated by the driver, e.g., pushed down like a button, to generate a signal that a function associated with the actuated actuator has been selected.

As shown in FIG. 2B, right hand controls 202 may include up label-less actuator 202a, right label-less actuator 202b, down label-less actuator 202c, left label-less actuator 202d, middle label-less actuator 202e, and driver adjustment actuator 202f. As the driver adjustment functionality may be considered of high importance, driver adjustment actuator 202f may be labeled as it may have the same functionality regarding of the vehicle control settings accessible as shown on display 150. Alternatively, driver adjustment 202f also may be label-less as shown in FIG. 1, and the function associated therewith may contextually depend on the vehicle control settings accessible. As will be understood by a person having ordinary skill in the art, right hand controls 202 may have less or more actuators, and the actuators may be arranged in a different configuration.

As shown in FIG. 2C, left hand controls 204 may include up label-less actuator 204a, right label-less actuator 204b, down label-less actuator 204c, left label-less actuator 204d, middle label-less actuator 204e, and driver assist actuator 204f. As the driver assist functionality may be considered of high importance, driver assist actuator 204f may be labeled as it may have the same functionality regarding of the vehicle control settings accessible as shown on display 150. Alternatively, driver assist actuator 204f also may be label-less as shown in FIG. 1, and the function associated therewith may contextually depend on the vehicle control settings accessible. As will be understood by a person having ordinary skill in the art, left hand controls 204 may have less or more actuators, and the actuators may be arranged in a different configuration.

Referring now to FIG. 3, components that may be included in steering wheel controller platform 300 are described in further detail. Steering wheel controller platform 300 may include one or more processors 302, communication system 304, and memory 306. Communication system 304 may include a wireless transceiver that allows steering wheel controller platform 300 to communicate with the electrical and mechanical components of the vehicle including e.g., right hand controls 202 and left hand controls 204 of steering wheel 200, steering wheel 200, display 150, the vehicle's audio system, the vehicle's entertainment system, the vehicle's mirrors, the vehicle's foot pedal, the vehicle's climate controls system, the vehicle's lighting system, etc. The wireless transceiver may use any of various communication formats, such as, for example, an Internet communications format, or a cellular communications format.

Memory 306, which is one example of a non-transitory computer-readable medium, may be used to store operating system (OS) 316, haptic sensors interface module 308, virtual display generation module 310, display interface module 312, and vehicle interface module 314. The modules are provided in the form of computer-executable instructions that may be executed by processor 302 for performing various operations in accordance with the disclosure.

Memory 306 may include any one memory element or a combination of volatile memory elements (e.g., random access memory (RAM, such as DRAM, SRAM, SDRAM, etc.)) and non-volatile memory elements (e.g., ROM, hard drive, tape, CDROM, etc.). Moreover, memory 306 may incorporate electronic, magnetic, optical, and/or other types of storage media. In the context of this document, a “non-transitory computer-readable medium” can be, for example but not limited to, an electronic, magnetic, optical, electromagnetic, infrared, or semiconductor system, apparatus, or device. More specific examples (a non-exhaustive list) of the computer-readable medium would include the following: a portable computer diskette (magnetic), a random-access memory (RAM) (electronic), a read-only memory (ROM) (electronic), an erasable programmable read-only memory (EPROM, EEPROM, or Flash memory) (electronic), and a portable compact disc read-only memory (CD ROM) (optical). The computer-readable medium could even be paper or another suitable medium upon which the program is printed, since the program can be electronically captured, for instance, via optical scanning of the paper or other medium, then compiled, interpreted or otherwise processed in a suitable manner if necessary, and then stored in a computer memory.

Haptic sensors interface module 308 may be executed by processor 302 for receiving the signal(s) generated by the actuators of right hand controls 202 and left hand controls 204 of the switch set of steering wheel 200. For example, haptic sensors interface module 308 may receive a signal indicative of when the driver engages with an actuator, but does not actuate the actuator, as well as a signal indicative of when the driver actuates the actuator.

Virtual display generation module 310 may be executed by processor 302 for generating a virtual display of right hand controls 202 and left hand controls 204, and the current functions associated with each of the actuators of the switch set contextually based on the vehicle control settings accessible. For example, the default functions of actuators 202a, 202b, 202c, and 202d may be up cursor, right cursor, down cursor, and left cursor, respectively, such that upon the driver actuating driver adjustment actuator 202f, the functions of actuators 202a, 202b, 202c, and 202d change to steering wheel adjustment, right mirror adjustment, foot pedal adjustment, and left mirror adjustment, respectively. Accordingly, upon actuation of driver adjustment actuator 202f, virtual display generation module 310 will generate a virtual display of right hand controls 202 and left hand controls 204, with the functions associated with right hand controls 202 being steering wheel adjustment, right mirror adjustment, foot pedal adjustment, and left mirror adjustment. In addition, virtual display generation module 310 may generate a virtual display illustrating an indicator to show the driver where their finger/thumb is relative to the switch set. For example, the indicator may include a circle around the particular actuator.

Display interface module 312 may be executed by processor 302 for causing display 150 to display the virtual display generated by virtual display generation module 310.

Vehicle interface module 314 may be executed by processor 302 for causing electrical and mechanical components of the vehicle to be actuated in accordance with the function actuated via the actuators of right hand controls 202 and left hand controls 204. For example, upon actuation of the mirror adjust function by the driver via the actuators of the switch set, vehicle interface module 314 may cause the mirror(s) of the vehicle to adjust in accordance with the actuation by the driver. Similarly, upon actuation of video playback settings by the driver via the actuators of the switch set, vehicle interface module 314 may cause a video playing on a screen of the vehicle to execute functions, e.g., play, pause, fast-forward, etc., in accordance with the actuation by the driver.

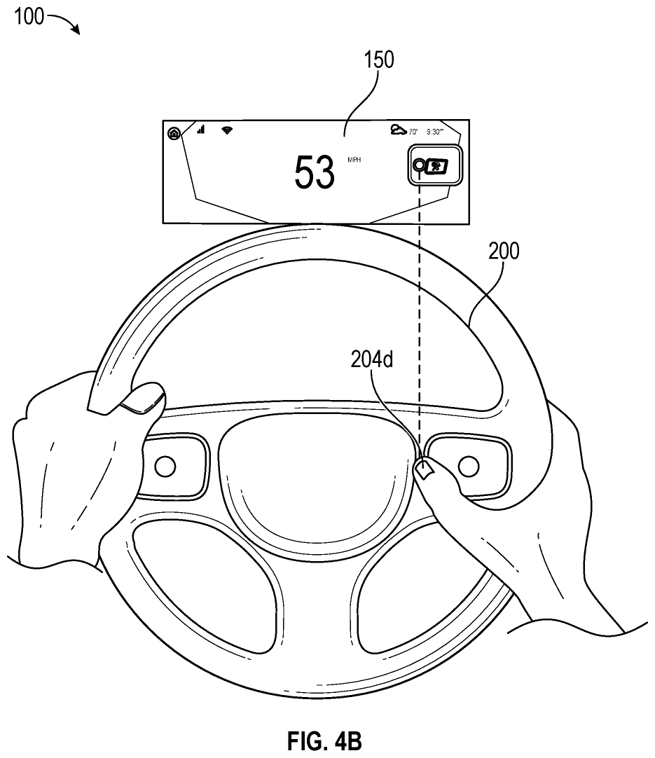

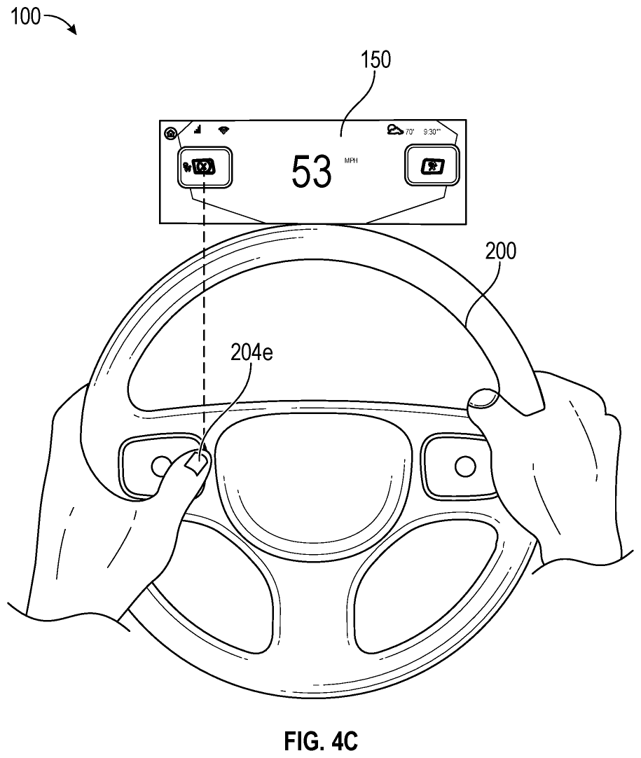

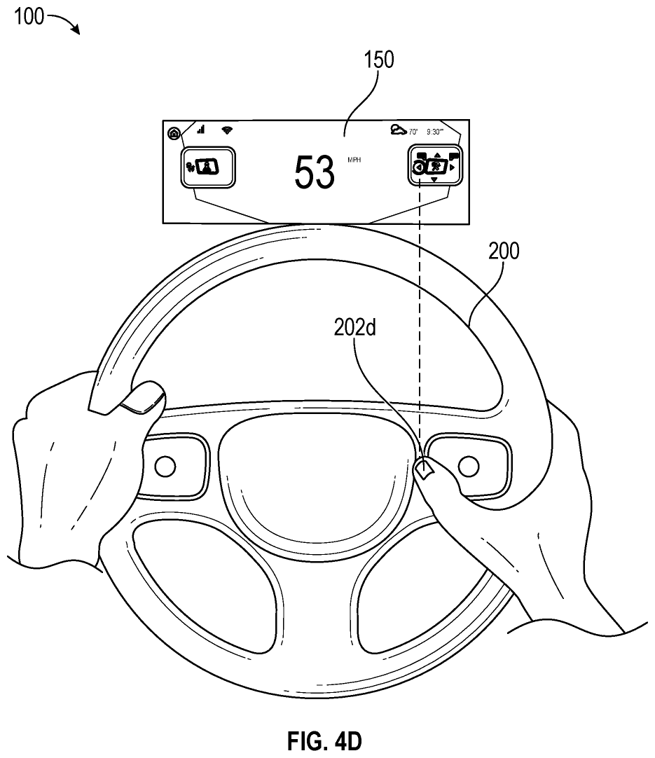

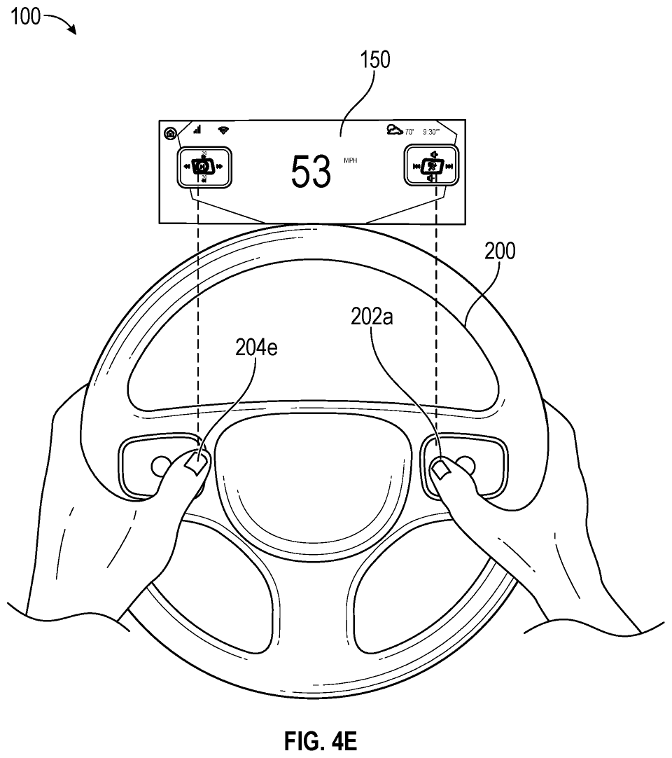

Referring now to FIG. 4A to 4F various functionalities of virtual steering wheel controller system 100 are provided. As shown in FIG. 4A, before the driver touches or otherwise interacts with the switch set of steering wheel 200, display 150 may not virtually display any vehicle control settings, e.g., a default blank display. As shown in FIG. 4A, the default blank display may include general information such as the speed of the vehicle, but no selectable functions of the vehicle control settings. Moreover, after a predetermined amount of time after the driver has interacted with the switch set, display 150 may stop virtually displaying the vehicle control settings and return to the default blank display.

As shown in FIG. 4B, when the driver engages their thumb with actuator 202d, display 150 virtually displays right hand controls 202 as well as an indicator on the virtual display of actuator 202d to show the driver where their thumb is relative to right hand controls 202. Similarly, as shown in FIG. 4C, when the driver engages their thumb with actuator 204e, display 150 virtually displays left hand controls 204 as well as an indicator on the virtual display of actuator 204e to show the driver where their thumb is relative to left hand controls 204.

As shown in FIG. 4D, the default functions associated with actuators 202a, 202b, 202c, 202d, and 202e of right hand controls 202 may be up cursor, right cursor, down cursor, left cursor, and OK, respectively, such that the driver may navigate through the vehicle control settings via the actuators 202a, 202b, 202c, 202d, and 202e. As shown in FIG. 4D, when the driver engages their thumb with actuator 202d, display 150 virtually displays right hand controls 202, the functions associated with each actuator of right hand controls 202, as well as an indicator on the virtual display of actuator 202d to show the driver where their thumb is relative to right hand controls 202.

In addition to providing functionalities to control vehicle control settings as described above, right hand controls 202 and left hand controls 204 may provide the user additional functionalities, for example, when the vehicle is stopped or operating under a self-driving mode. For example, the user may actuate control functions for watching a movie or playing video games via right hand controls 202 and/or left hand controls 204 when the vehicle is stopped or operating under a self-driving mode. Accordingly, as shown in FIG. 4E, right hand controls 202 and left hand controls 204 may have functions to control video playback when the vehicle is playing a video. For example, actuators 202a, 202b, 202c, and 202d of right hand controls 202 may include the functions of volume up, skip scene forward, volume down, and skip scene backward, respectively, and actuators 204a, 204b, 204c, 204d, and 204e of left hand controls 204 may include the functions of forward 30 seconds, fast forward, backwards 30 seconds, fast backwards, and play/pause, respectively. Upon actuation of any of the video playback functions described herein, the vehicle may execute the actuated function, e.g., pause or play the video.

Moreover, as shown in FIG. 4F, the actuators of right hand controls 202 and left hand controls 204 may function as a video game remote controller, e.g., when the driver is playing a video game displayed on display 150. As will be understood by a person having ordinary skill in the art, the actuators of right hand controls 202 and left hand controls 204 may have limitless functions based on the vehicle control settings accessed by the driver.

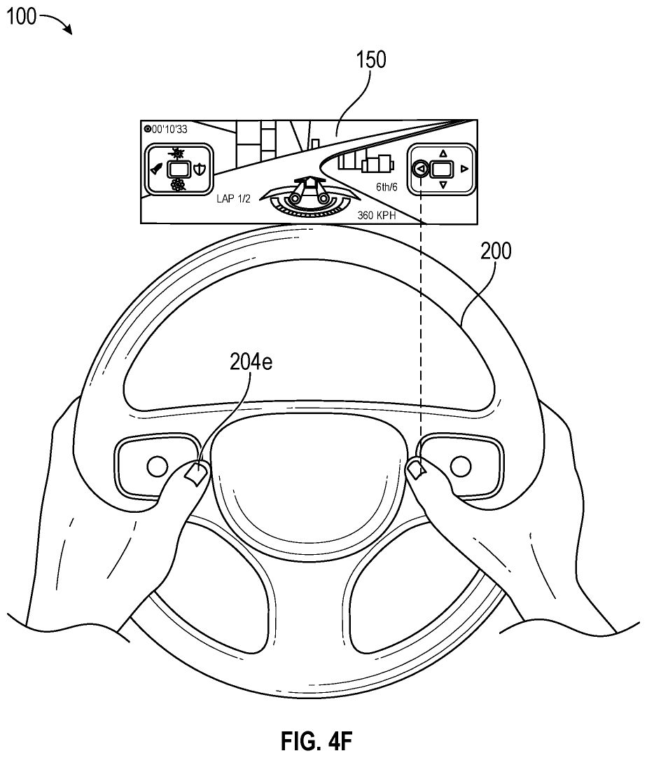

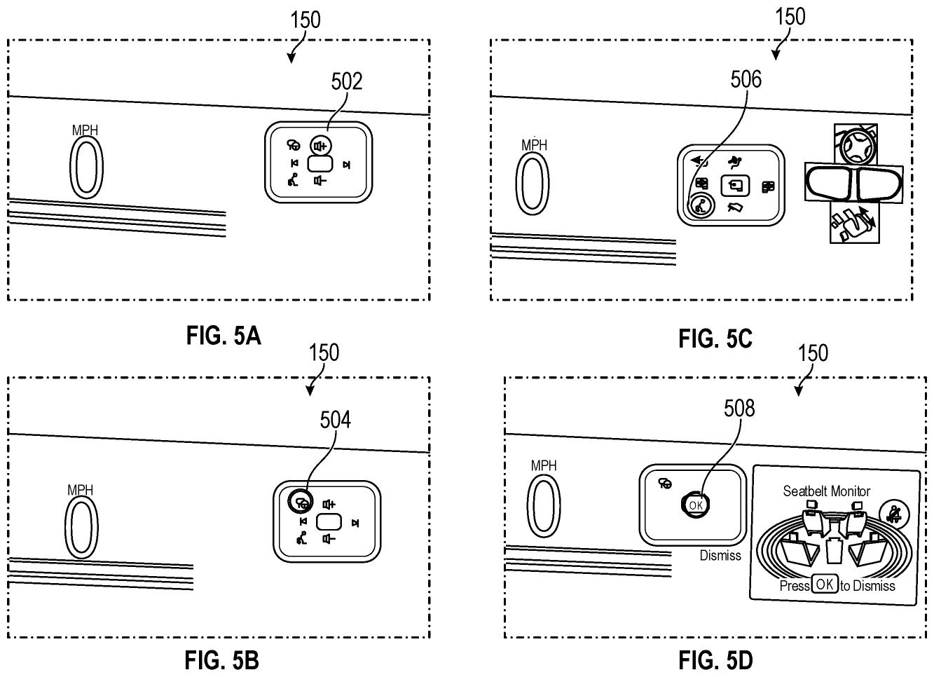

Referring now to FIGS. 5A to 5D, various exemplary functionalities of right hand controls 202 are illustrated. As described above, the functionalities contextually provided to the user may be executed to control vehicle control settings such as driver adjustments while the driver is operating the vehicle, as well as entertaining settings such as video playback or video game controls when the vehicle is stopped or operating under a self-driving mode. As shown in FIG. 5A, actuators 202a, 202b, 202c, and 202d of right hand controls 202 may include the functions of volume up, skip scene forward, volume down, and skip scene backward, respectively, which are virtually displayed on display 150, e.g., when the vehicle is playing audio or video. In addition, actuator 202f may include the driver adjustment function and another actuator, e.g., the bottom left actuator between actuators 202c and 202d, may include a digital assistant function, as described in further detail below, which are both also virtually displayed on display 150. As shown in FIG. 5A, interaction of the driver's thumb/finger with actuator 202a causes display 150 to virtually display indicator 502 over the volume up function associated with actuator 202a in the current audio/video vehicle control settings.

As shown in FIG. 5B, interaction of the driver's thumb/finger with actuator 202f causes display 150 to virtually display indicator 504 over the driver adjustment function associated with actuator 202f in the current audio/video vehicle control settings. As shown in FIG. 5C, upon actuation of the driver adjustment function by the driver, e.g., by actuating actuator 202f in FIG. 5B, the functions associated with actuators 202a, 202b, 202c, 202d, 202e, and 202f change to steering wheel adjustment, right mirror adjustment, foot pedal adjustment, left mirror adjustment, mirror fold adjustment, and return, respectively, as virtually displayed by display 150. In addition, interaction of the driver's thumb/finger with the actuator associated with the digital assistant function causes display 150 to virtually display indicator 506 over the digital assistant function associated with that actuator in the current driver adjustment vehicle control settings.

As shown in FIG. 5D, display 150 further may display vehicle alerts in real-time, such as a passenger failing to buckle their seatbelt, such that the alert may be dismissed using the actuators of the switch set. For example, when the seatbelt alert is displayed on display 150, display 150 may virtually display right hand controls 202, and the function associated with actuator 202e may be OK, such that actuation of actuator 202e executes the OK function to dismiss the seatbelt alert. As will be understood by a person having ordinary skill in the art, display 150 may display other vehicle alerts, which may be dismissed or otherwise addressed by the driver via the switch set.

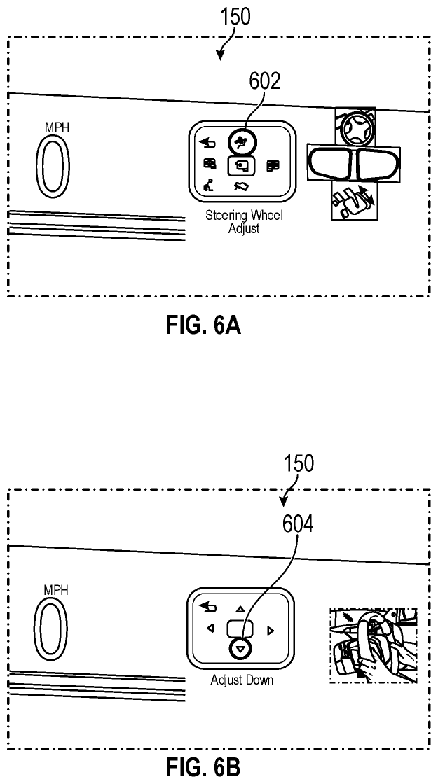

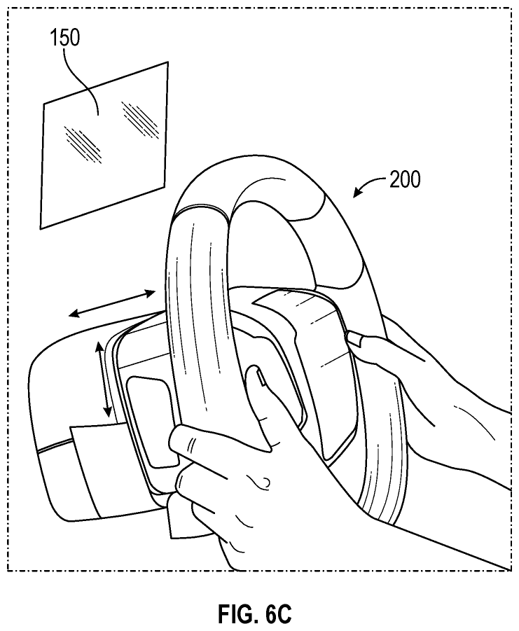

Referring now to FIGS. 6A to 6C, steering wheel adjustment functionality of system 100 is illustrated. As shown in FIG. 6A, actuators 202a, 202b, 202c, 202d, and 202e of right hand controls 202 may include the functions of steering wheel adjustment, right mirror adjustment, foot pedal adjustment, left mirror adjustment, and mirror fold adjustment, respectively. As shown in FIG. 6A, interaction of the driver's thumb/finger with actuator 202a causes display 150 to virtually display indicator 602 over the steering wheel adjustment function associated with actuator 202a in the current driver adjustment vehicle control settings.

As shown in FIG. 6B, upon actuation of the steering wheel adjustment function by the driver, e.g., by actuating actuator 202a in FIG. 6A, the functions associated with actuators 202a, 202b, 202c, 202d, and 202e change to up cursor, right cursor, down cursor, left cursor, and blank, respectively, as virtually displayed by display 150. As shown in FIG. 6B, interaction of the driver's thumb/finger with actuator 202c causes display 150 to virtually display indicator 604 over the down cursor function associated with actuator 202c in the current steering wheel adjustment vehicle control settings. As shown in FIG. 6C, upon actuation of the down cursor function by the driver, e.g., by actuating actuator 202c in FIG. 6B, steering wheel 200 will be moved downward. Steering wheel 200 may be moved in the direction corresponding with the directional cursor actuated by the driver, e.g., up, down, left, right.

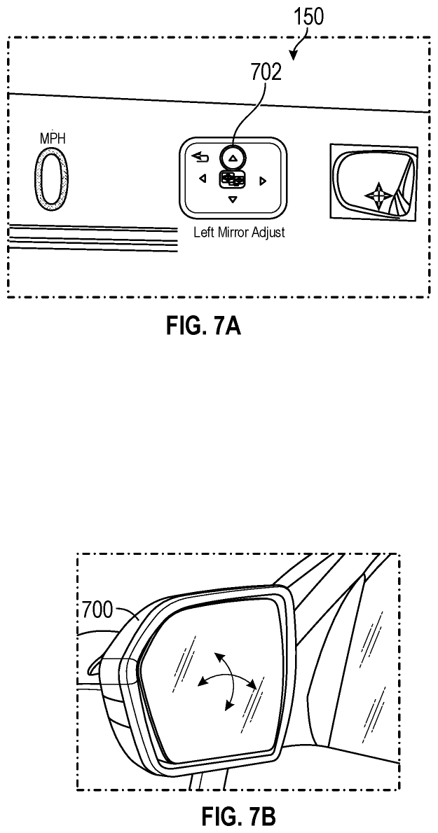

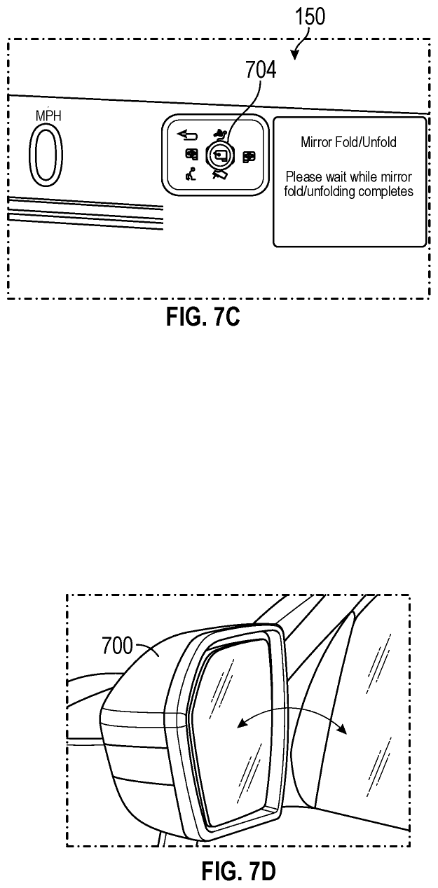

Referring now to FIGS. 7A to 7D, mirror adjustment functionality of system 100 is illustrated. As shown in FIG. 7A, upon actuation of the left mirror adjustment function by the driver, e.g., by actuating actuator 202d in FIG. 6A, the functions associated with actuators 202a, 202b, 202c, 202d, and 202e change to up cursor, right cursor, down cursor, left cursor, and left to right mirror adjustment, respectively, as virtually displayed by display 150. As shown in FIG. 7A, interaction of the driver's thumb/finger with actuator 202a causes display 150 to virtually display indicator 702 over the up cursor associated with actuator 202a in the current left mirror adjustment vehicle control settings. As shown in FIG. 7B, upon actuation of the up cursor function by the driver, e.g., by actuating actuator 202a in FIG. 7A, left mirror 700 will be moved upward. Left mirror 700 may be moved in the direction corresponding with the directional cursor actuated by the driver, e.g., up, down, left, right.

As shown in FIG. 7C, interaction of the driver's thumb/finger with actuator 202e causes display 150 to virtually display indicator 704 over the mirror fold adjustment function associated with actuator 202e in the current driver adjustment vehicle control settings. Upon actuation of the mirror fold adjustment function by the driver, e.g., by actuating actuator 202e in FIG. 7C, left mirror 700 may fold inward toward the vehicle. If left mirror 700 is in the folded configuration, actuation of the mirror fold adjustment function by the driver will cause left mirror 700 to fold outward away from the vehicle. As will be understood by a person having ordinary skill in the art, the vehicle's right and left mirrors may be folded/unfolded in tandem.

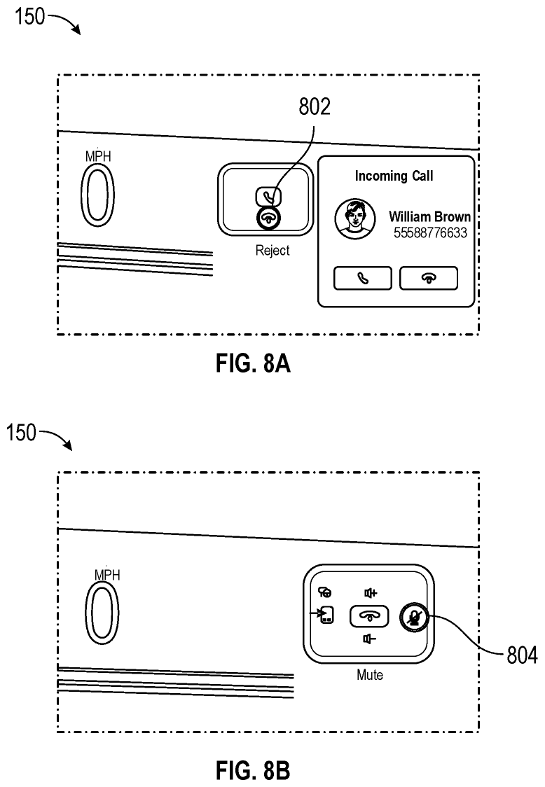

As shown in FIG. 8A, when the vehicle is synced with a mobile device, e.g., the driver's cellular phone, an incoming call may be displayed on display 150. Accordingly, the function associated with actuator 202c of right hand controls 202 may change to a decline function, and the function associated with actuator 202e may change to an answer function. As shown in FIG. 8A, interaction of the driver's thumb/finger with actuator 202c causes display 150 to virtually display indicator 802 over the decline function associated with actuator 202c in the incoming call vehicle control settings.

As shown in FIG. 8B, upon actuation of the answer function by the driver, e.g., by actuating actuator 202e in FIG. 8A, the functions associated with actuators 202a, 202b, 202c, 202d, and 202e change to volume up, mute, volume down, switch to mobile device, and hang-up, respectively, as virtually displayed by display 150. As shown in FIG. 8B, interaction of the driver's thumb/finger with actuator 202b causes display 150 to virtually display indicator 804 over the mute function associated with actuator 202b in the ongoing call vehicle control settings.

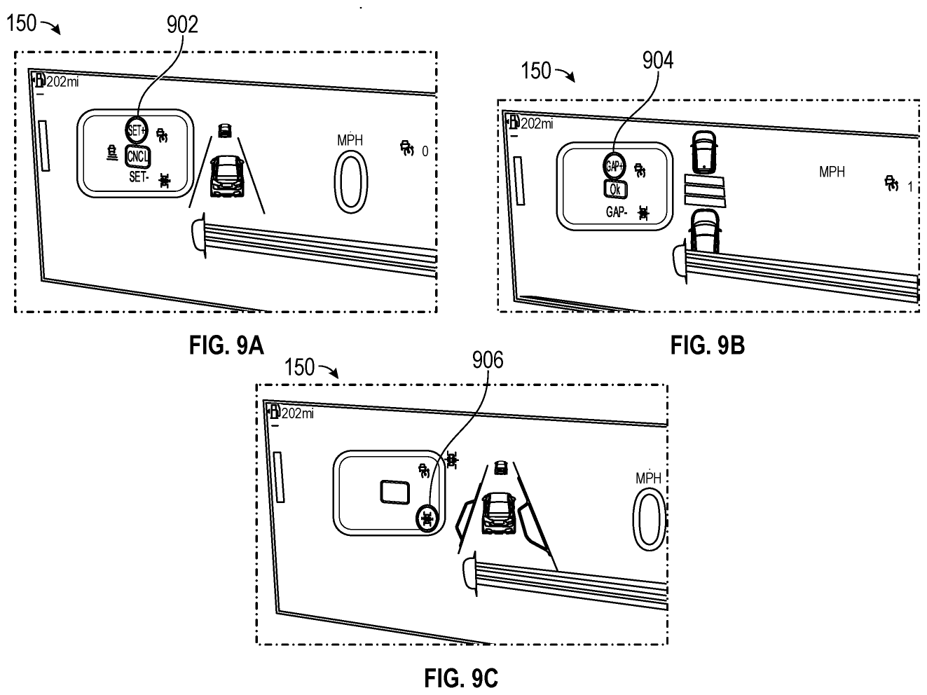

Referring now to FIGS. 9A to 9C, driver assist functionalities of system 100 are illustrated. As shown in FIG. 9A, upon actuation of the driver assist function by the driver, e.g., by actuating driver assist actuator 204f in FIG. 2C, the functions associated with actuators 204a, the lane actuator between actuators 204b and 204c, 204c, 204d, and 204e change to set increase, lane keep assist, set decrease, vehicle gap, and cancel, respectively. As shown in FIG. 9A, interaction of the driver's thumb/finger with actuator 204a causes display 150 to virtually display indicator 902 over the set increase function associated with actuator 204a in the driver assist cruise control vehicle control settings. The driver may adjust and set the cruise control speed of the vehicle using left hand controls 204 of the switch set of steering wheel 200.

As shown in FIG. 9B, upon actuation of the vehicle gap function by the driver, e.g., by actuating driver assist actuator 204d in FIG. 9A, the functions associated with actuators 204a and 204c change to gap increase and gap decrease, respectively. As shown in FIG. 9B, interaction of the driver's thumb/finger with actuator 204a causes display 150 to virtually display indicator 904 over the gap increase function associated with actuator 204a in the driver assist vehicle gap vehicle control settings. The driver may adjust and set the gap distance between the vehicle and an adjacent vehicle, e.g., a front vehicle, using left hand controls 204 of the switch set of steering wheel 200.

As shown in FIG. 9C, upon actuation of the lane keep assist function by the driver, e.g., by actuating the lane actuator between actuators 204b and 204c in FIG. 9A, the vehicle may engage in lane keep assist, which may be displayed on display 150.

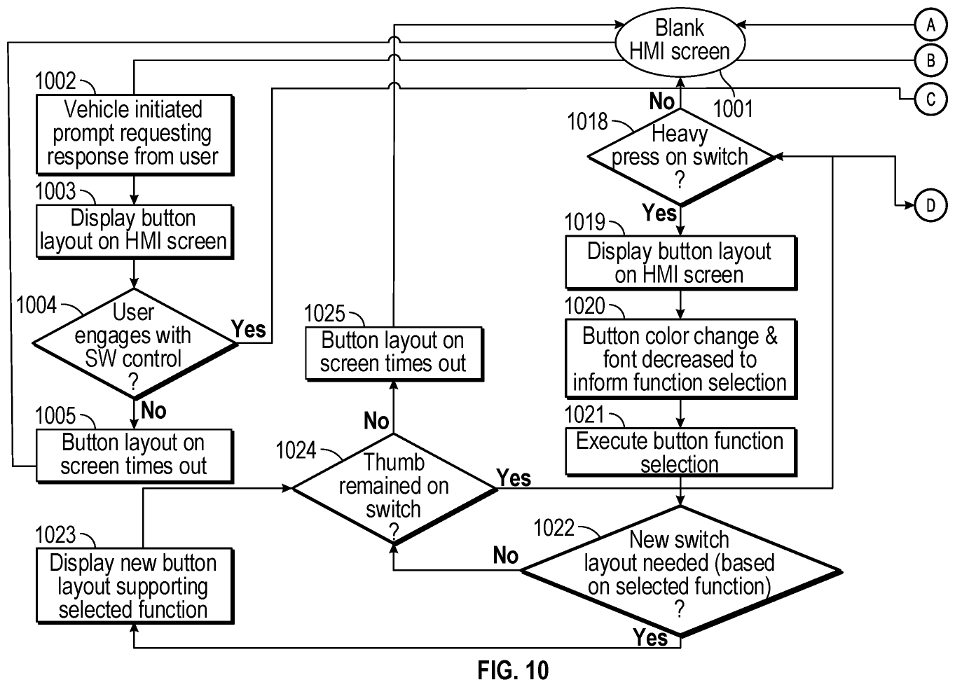

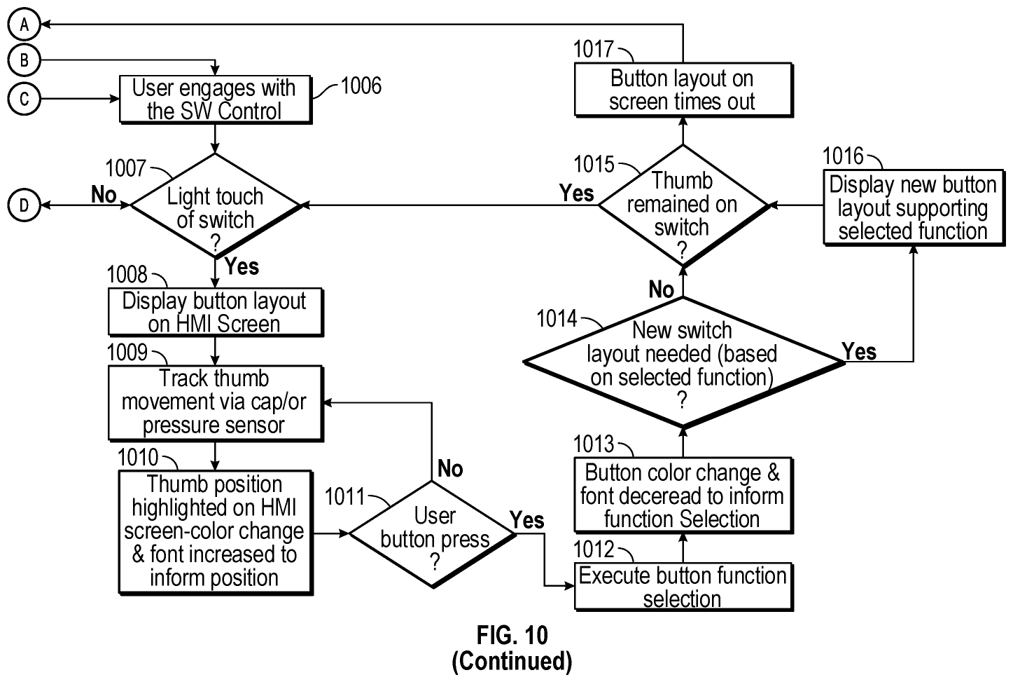

Referring now to FIG. 10, an exemplary method for controlling vehicle control settings is provided. At step 1001, display 150, e.g., a human-machine interface (HMI) screen, is blank. At step 1002, a vehicle initiated prompt requests a response from the user, e.g., the driver. At step 1003, the switch set is virtually displayed on display 150. At step 1004, the system determines whether the user engages with the actuators of the switch set. If the user does not engage with the actuators of the switch set at step 1004, display 150 times out due to inactivity, and the method returns to step 1001 where display 150 displays a blank screen. If the user engages with the actuators of the switch set at step 1004, at step 1006, the user continues to engage with the actuators of the switch set.

The method may proceed from step 1001 directly to step 1006 upon engagement of the actuators of the switch set by the user. Next, at step 1007, the system determines whether the user's engagement with the actuator is a light touch. If the user's engagement with the actuator is a light touch, the method proceeds to step 1008 where display 150 virtually displays the switch set on the HMI screen. At step 1009, the system tracks the movement of the user's thumb/finger, e.g., via the haptic sensors integrated with the actuators of the switch set. At step 1010, display 150 virtually displays an indicator showing the position of the user's thumb/finger relative to the switch set. For example, the indicator may be a circle, a color change, and/or enlarged font, to convey to the user the position of their thumb/finger relative to the switch set.

At step 1011, the system determines whether the user actuated an actuator, e.g., by pressing down on the actuator. If the user did not actuate the actuator, the method returns to step 1009. If the user actuated the actuator, the method proceeds to step 1012 where the vehicle executes the function associated with the actuated actuator. At step 1013, display 150 may display, e.g., a color change and/or a font decrease to inform the user that the function has been selected. At step 1014, the system determines whether a new switch layout, e.g., virtually displayed functions associated with the actuators of the switch set, is required based on the selected function at step 1012. At step 1015, if a new switch layout is not required, the system determines whether the user's thumb/finger remains on the actuator. If the user's thumb/finger does not remain on the switch set, at step 1017, display 150 times out due to inactivity, and the method returns to step 1001 where display 150 displays a blank screen. If the user's thumb/finger does remain on the switch set, the method proceeds to step 1007, where the system determines whether the user's engagement with the actuator is a light touch. If at step 1014, a new switch layout is required, the method proceeds to step 1016, where display 150 virtually displays the new layout, e.g., new set of functions associated with each actuator of the switch set. Next the method proceeds to step 1015 to determine whether the user's thumb/finger remains on the switch set.

If at step 1007, the user's engagement with the actuator is not a light touch, the method proceeds to step 1018, where the system determines whether the user's engagement with the actuator is a heavy touch, e.g., whether the user actuated the actuator. If the user's engagement with the actuator is not a heavy touch, the method returns to step 1001 where display 150 displays a blank screen. If the user's engagement with the actuator is a heavy touch, the method proceeds to step 1019, where display 150 virtually displays the switch set on the HMI screen. At step 1020, display 150 may display, e.g., a color change and/or a font decrease to inform the user that the function has been selected. At step 1021, the vehicle executes the function associated with the actuated actuator.

At step 1022, the system determines whether a new switch layout, e.g., virtually displayed functions associated with the actuators of the switch set, is required based on the selected function at step 1021. At step 1024, if a new switch layout is not required, the system determines whether the user's thumb/finger remains on the actuator. If the user's thumb/finger does not remain on the switch set, at step 1025, display 150 times out due to inactivity, and the method returns to step 1001 where display 150 displays a blank screen. If the user's thumb/finger does remain on the switch set, the method proceeds to step 1009, where the system determines whether the user's engagement with the actuator is a light touch. If at step 1022, a new switch layout is required, the method proceeds to step 1023, where display 150 virtually displays the new layout, e.g., new set of functions associated with each actuator of the switch set. Next the method proceeds to step 1024 to determine whether the user's thumb/finger remains on the switch set.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, one skilled in the art will recognize such feature, structure, or characteristic in connection with other embodiments whether or not explicitly described.

Implementations of the systems, apparatuses, devices, and methods disclosed herein may comprise or utilize one or more devices that include hardware, such as, for example, one or more processors and system memory, as discussed herein. An implementation of the devices, systems, and methods disclosed herein may communicate over a computer network. A “network” is defined as one or more data links that enable the transport of electronic data between computer systems and/or modules and/or other electronic devices. When information is transferred or provided over a network or another communications connection (either hardwired, wireless, or any combination of hardwired or wireless) to a computer, the computer properly views the connection as a transmission medium. Transmission media can include a network and/or data links, which can be used to carry desired program code means in the form of computer-executable instructions or data structures and which can be accessed by a general purpose or special purpose computer. Combinations of the above should also be included within the scope of non-transitory computer-readable media.

Computer-executable instructions comprise, for example, instructions and data which, when executed at a processor, cause the processor to perform a certain function or group of functions. The computer-executable instructions may be, for example, binaries, intermediate format instructions, such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the present disclosure may be practiced in network computing environments with many types of computer system configurations, including in-dash vehicle computers, personal computers, desktop computers, laptop computers, message processors, handheld devices, multi-processor systems, microprocessor-based or programmable consumer electronics, network PCs, minicomputers, mainframe computers, mobile telephones, PDAs, tablets, pagers, routers, switches, various storage devices, and the like. The disclosure may also be practiced in distributed system environments where local and remote computer systems, which are linked (either by hardwired data links, and/or wireless data links) through a network, both perform tasks. In a distributed system environment, program modules may be located in both the local and remote memory storage devices.

Further, where appropriate, the functions described herein may be performed in one or more of hardware, software, firmware, digital components, or analog components. For example, one or more application specific integrated circuits (ASICs) may be programmed to carry out one or more of the systems and procedures described herein. Certain terms are used throughout the description, and claims refer to particular system components. As one skilled in the art will appreciate, components may be referred to by different names. This document does not intend to distinguish between components that differ in name, but not function.

At least some embodiments of the present disclosure have been directed to computer program products comprising such logic (e.g., in the form of software) stored on any computer-usable medium. Such software, when executed in one or more data processing devices, causes a device to operate as described herein.

While various embodiments of the present disclosure have been described above, it should be understood that they have been presented by way of example only, and not limitation. It will be apparent to persons skilled in the relevant art that various changes in form and detail can be made therein without departing from the spirit and scope of the present disclosure. Thus, the breadth and scope of the present disclosure should not be limited by any of the above-described example embodiments but should be defined only in accordance with the following claims and their equivalents. The foregoing description has been presented for the purposes of illustration and description. It is not intended to be exhaustive or to limit the present disclosure to the precise form disclosed. Many modifications and variations are possible in light of the above teaching. Further, it should be noted that any or all of the aforementioned alternate implementations may be used in any combination desired to form additional hybrid implementations of the present disclosure. For example, any of the functionality described with respect to a particular device or component may be performed by another device or component. Further, while specific device characteristics have been described, embodiments of the disclosure may relate to numerous other device characteristics. Further, although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

What is claimed:

1. A virtual steering wheel controller system for controlling vehicle control settings of a vehicle, the system comprising:
a steering wheel operatively coupled to the vehicle, the steering wheel comprising a plurality of label-less actuators, each of the plurality of label-less actuators comprising a sensor configured to generate a signal upon interaction with a driver;
a display positioned within a line-of-sight of the driver of the vehicle, the display operatively coupled to the plurality of label-less actuators;
a memory that stores computer-executable instructions; and
a processor configured to access the memory and execute the computer-executable instructions to:
receive the signal from the plurality of label-less actuators;
cause the display to virtually display the plurality of label-less actuators, one or more functions associated therewith, and an indicator based on the signal; and
cause the vehicle to execute a function of the one or more functions upon actuation of at least one of the plurality of label-less actuators to control vehicle control settings of the vehicle;
wherein the virtually displayed one or more functions associated with the plurality of label-less actuators are contextually dependent on the vehicle control settings accessed based on the signal.

2. The system of claim 1, wherein the sensor comprises a haptic sensor.

3. The system of claim 2, wherein the haptic sensor is configured to provide a haptic response to tactilely communicate the interaction with the plurality of label-less actuators to the driver.

4. The system of claim 1, wherein the display is configured to virtually display the plurality of label-less actuators and the one or more functions associated therewith for a predetermined time period upon receipt of the signal from the plurality of label-less actuators.

5. The system of claim 1, wherein the display is integrated with a dashboard of the vehicle.

6. The system of claim 1, wherein the display comprises a heads up display.

7. The system of claim 1, wherein the one or more functions associated with the plurality of label-less actuators comprise functions to control vehicle control settings comprising music settings.

8. The system of claim 1, wherein the one or more functions associated with the plurality of label-less actuators comprise functions to control vehicle control settings comprising video playback settings.

9. The system of claim 1, wherein the one or more functions associated with the plurality of label-less actuators comprise functions to control vehicle control settings comprising steering wheel configuration settings.

10. The system of claim 1, wherein the one or more functions associated with the plurality of label-less actuators comprise functions to control vehicle control settings comprising mirror configuration settings.

11. The system of claim 1, wherein the one or more functions associated with the plurality of label-less actuators comprise functions to control vehicle control settings comprising call settings.

12. The system of claim 1, wherein the one or more functions associated with the plurality of label-less actuators comprise functions to control vehicle control settings comprising cruise control settings.

13. The system of claim 12, wherein the cruise control settings comprise at least one of distance between adjacent vehicles or cruise control speed.

14. The system of claim 1, wherein the one or more functions associated with the plurality of label-less actuators comprise functions to control vehicle control settings comprising video game control settings.

15. A method for virtually controlling vehicle control settings of a vehicle, the method comprising:
receiving a signal from a plurality of label-less actuators integrated with a steering wheel of the vehicle upon interaction of a driver of the vehicle with the plurality of label-less actuators;
virtually displaying, upon receipt of the signal, the plurality of label-less actuators, one or more functions associated therewith, and an indicator based on the signal on a display within a line-of-sight of the driver;
executing a function of the one or more functions upon actuation of at least one of the plurality of label-less actuators to control vehicle control settings of the vehicle;
wherein the virtually displayed one or more functions associated with the plurality of label-less actuators are contextually dependent on the vehicle control settings accessed based on the signal.

16. The method of claim 15, wherein each of the plurality of label-less actuators comprise a haptic sensor configured to generate a signal upon interaction with the driver.

17. The method of claim 16, further comprising providing a haptic response to tactilely communicate the interaction with the plurality of label-less actuators to the driver.

18. The method of claim 15, wherein virtually displaying, upon receipt of the signal, the plurality of label-less actuators and the one or more functions associated therewith comprises virtually displaying the plurality of label-less actuators and the one or more functions associated therewith for a predetermined time period upon receipt of the signal from the plurality of label-less actuators.

19. The method of claim 15, wherein the one or more functions associated with the plurality of label-less actuators comprise functions to control vehicle control settings comprising at least one of music settings, video playback settings, steering wheel configuration settings, mirror configuration settings, call settings, cruise control settings, or video game control settings.

20. The method of claim 19, wherein the cruise control settings comprise at least one of distance between adjacent vehicles or cruise control speed.
